(19) United States
(12) Patent Application Publication
(10) Pub. No.: US 2022/0299969 A1
(43) Pub. Date: Sep. 22, 2022

(54) COMMUNICATION SYSTEM AND MACHINE DEVICE

(71) Applicant: ZEITFRACHT GMBH & CO. KGAA, Berlin (DE)

(72) Inventors: Matthias BECK, Metzingen (DE); Matthias STANIEK, Metzingen (DE); Marius EWALD, Pfullingen (DE); Martin WORCH, Filderstadt (DE)

(21) Appl. No.: 17/641,579

(22) PCT Filed: Aug. 17, 2020
(86) PCT No.: PCT/EP2020/073017

§ 371 Date: Mar. 9, 2022

(30) Foreign Application Priority Data
Sep. 10, 2019 (DE) 10 2019 006 482.8

(51) Int. Cl. G05B 19/402

(52) U.S. Cl. CPC G05B 19/402; G05B 2219/37336

(57) ABSTRACT

Communication system and machine device.

A communication system consisting of at least one
data acquisition device (94) for acquiring sensor data of at least one machine device provided for cutting machining, preferably in real time,
data collection device (102) for digitizing the collected data, and
a data evaluation device (122) for the collected digitized data.

The invention relates to a communication system in conjunction with a machine device, in particular provided for such a communication system and in particular as part of such a communication system, in the form of a tool turret or a rotary table having a housing part and a receiving part, which can be fixed relative thereto in predeterminable angular positions starting from a release position.

From DE 10 2009 042 772 A1 by way of example such a tool turret is known, which has a drive device for the optional drive of a tool disk in relation to a stationary housing part, which is used as a swiveling and fixable receiving part for tool holders having cutting working tools.

From DE 198 53 590 C1 a rotary table is known as a machine device, which for generating a clamping in the context of indexing rotary indexing tables has in relation to a preferably stationary arranged table part a further table part as a swiveling and fixable receiving part for workpieces to be clamped.

The above-mentioned machine devices are only shown by way of example and in the state of the art there is a large number of different device solutions in this field. Recently, future projects for the comprehensive digitization of industrial production have been developed in the area of artificial intelligence (AI), designated by the catchword “Industry 4.0”. Intelligent and digitally linked communication systems constitute the technical basis thereof, wherein on the basis of said communication systems a largely self-organizing production system should be made possible. The objective is that people, machines, plants, logistics and products communicate and cooperate directly with each other, such that interconnectedness can be used to define not only one production step but an entire value chain. In the field of the machine devices in question in the form of tool turrets or rotary tables, nothing has yet been developed in this direction.

Although it has already been proposed for tool turrets of classical structure to collect various sensor data and to evaluate them partially; this does not constitute a modern communication system that could be used in the context of implementing industry 4.0 concepts. WO 2018/099697 A1 shows, by way of example, a tool holder for receiving rotary driven, cutting working tools, wherein said tool holder can be partially inserted in receptacles of a tool disk of a tool turret and at the housing of said tool holder a sensor module is arranged, which in turn is connected to a sensor unit and arranged in an area outside the fluid duct for the supply of cooling lubricant to the respective working tool and which detects the presence of fluid outside of this fluid duct in the context of fault detection for a smooth operation.

Accordingly, the invention addresses the object of creating a communication system and of providing interfaces for the implementation of the latter at machine devices, wherein said interfaces ensure a smooth communication and which especially permit the integration of respective machine devices into Industry 4.0 or AI concepts.

A communication system having the features of patent claim 1 and a machine device, in particular as part of such a communication system, having the features of patent claim 2 solve this problem.

The communication system according to the invention has as minimum equipment at least one
data acquisition device for acquiring sensor data of at least one machine device provided for cutting machining, preferably in real time, and
data collection device for digitizing the collected data, and
data evaluation device for the collected digitized data.

In this way, amongst other things, a bidirectional communication between the data evaluation device, in the following referred to as IQ box, and individual data collection devices can be implemented via a bus system. This results in a self-configuring network, i.e. the IQ box is able to check which participants in the form of individual machine devices are active on the bus and it configures the individual bus participants accordingly. This results in a simple exchangeability of components without service technicians having to change basic configurations of the machine devices and their controls.

Furthermore, the IQ box can write status data to the respective data collection device and, by integrating the cloud, preferably in the context of local cloud servers, a permanent remote update capability of the system can be achieved, for instance via the manufacturer of the machine or the device, at the place of installation.

The data collection devices themselves can also collect status information, such as operating hours, the number of temperature excesses or whatever else results from the sensor data of the machine device collected by various sensors.

In addition, with the communication system according to the invention a near field communication (NFC) can be realized; an international transmission standard based on RFID technology for the contactless exchange of data by electromagnetic induction. Other contactless transponder transmission technologies can also be used in the context of implementing the communication system in these cases.

Further functionalities of the communication system according to the invention in the context of the Industry 4.0 concept can be the acquisition of usage data, such as the creation of processing histograms, the monitoring of service life and the acquisition of extreme values concerning the evaluation of sensor data. Furthermore, tool compensation data can be read or written via the communication system, for instance concerning the clamping length of drills, cutter radius compensation values, etc.

The communication system can be used to ‘train’ an AI system using a large amount of collected data, possibly including the creation of a so-called digital twin for each machine device delivered, which permits an optimization of the service and sales concept.

Basically, if the usual data security regulations are observed, the respective machine device in the form of the tool turret or the turntable can then be controlled and serviced from the outside using internal machine controls (PLC control), but also externally via the cloud using the communication system according to the invention.

For implementing an interface connection in particular suitable for the communication system according to the invention, it is provided, preferably in a machine device in the form of the tool turret or the rotary table, to form at least one part of at least one information- and/or energy-conveying transmission link between the parts movable relative to one another in a fixed state of the mentioned parts to each other and to interrupt it in the release position for an interference-free operation of both the machine device and the assignable communication system.

In accordance with the contents of the further dependent claims, two interface concepts have been found to be particularly significant, one in the form of an external and one in the form of an internal communication interface. The advantage of the external communication interface is that the corresponding device can also be brought into action at previously delivered machine devices after they have been delivered to the customer. In contrast, the internal interface has the advantage that it is protected from external damage (danger of collision during processing) and in this way preferably all relevant components of the communication system can also be installed internally protected in the respective machine device, also protected from fluid.

Below, the communication system according to the invention, together with the assigned machine device is explained in more detail with reference to the drawing. In the figures, in principle and not to scale,

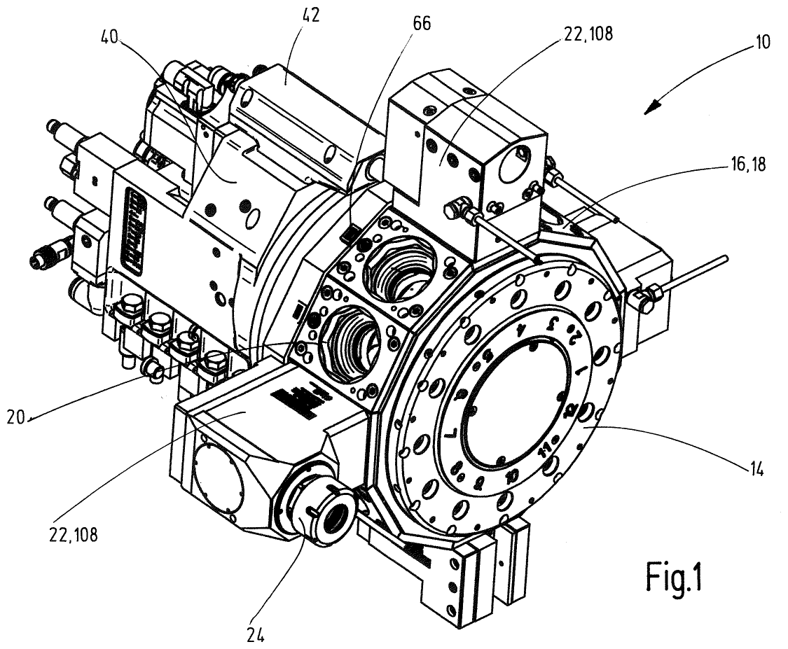

FIG. 1 shows a perspective view of a tool turret having a tool disk, which can be swiveled in relation to a stationary housing part and having individual, circumferentially arranged receptacles for tool holders of cutting working tools;

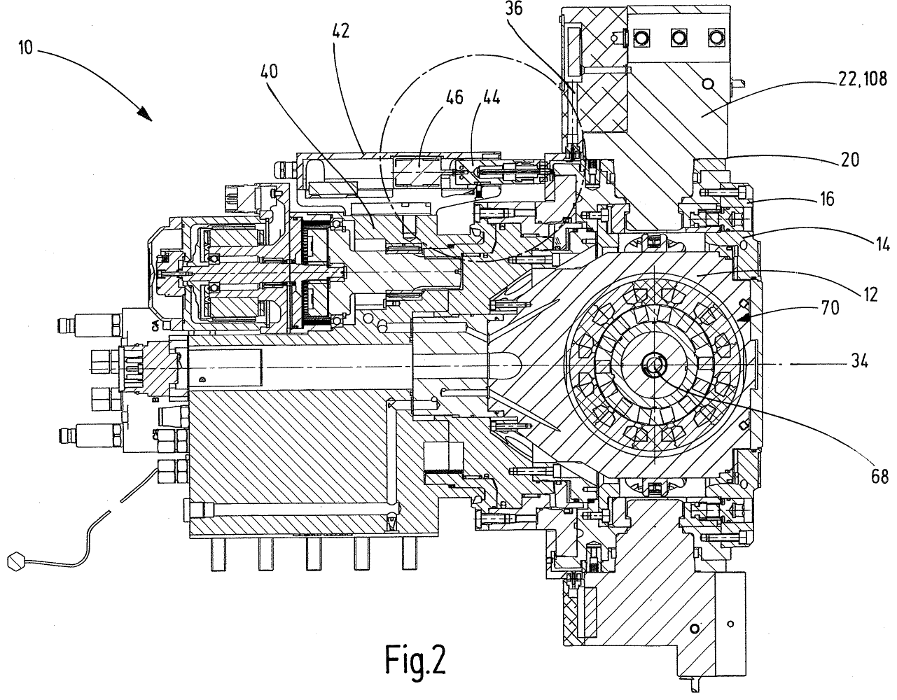

FIG. 2 shows a section through the tool turret of FIG. 1;

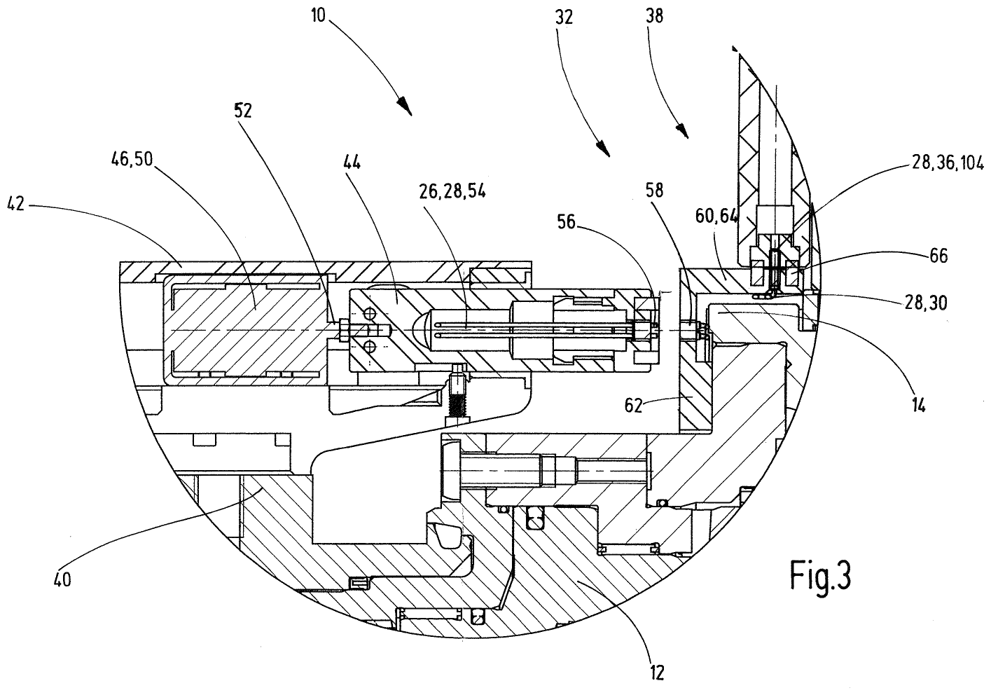

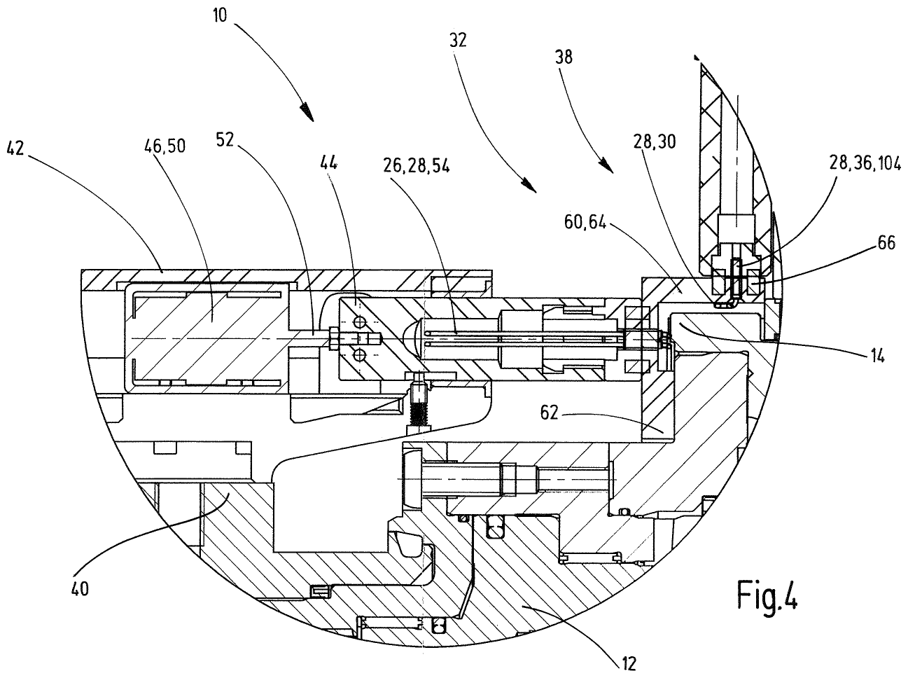

FIGS. 3 and 4 show a first form of a contacting device for establishing a transmission link within the context of a communication system, which is externally mounted on the tool turret, shown once in the decoupled position and once in the coupled position;

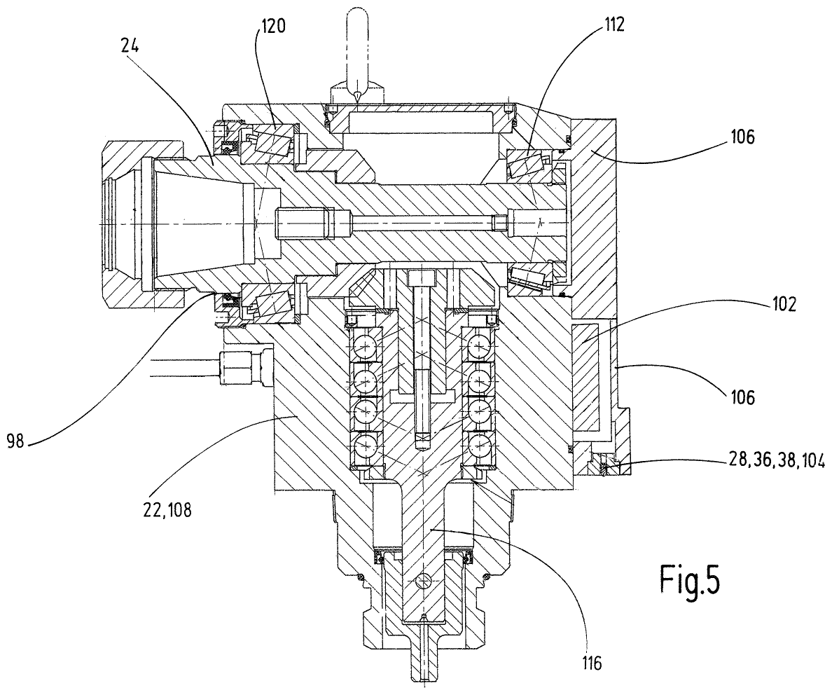

FIG. 5 shows a longitudinal section through a customary tool holder device, which has a male connector contact or female connector contact of the contacting device in its rear wall area facing away from the spindle receiving, and free spaces for a cable routing from and to individual sensors within the tool holder device;

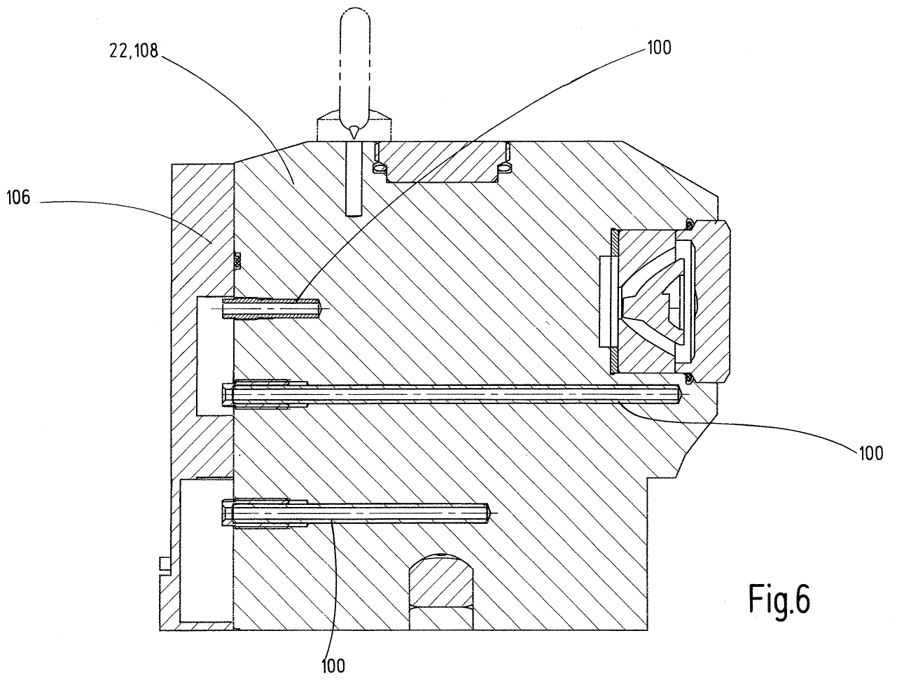

FIG. 6 shows an unspecified partial section of the tool holder according to FIG. 5 having individual mounting ducts for receiving individual sensors;

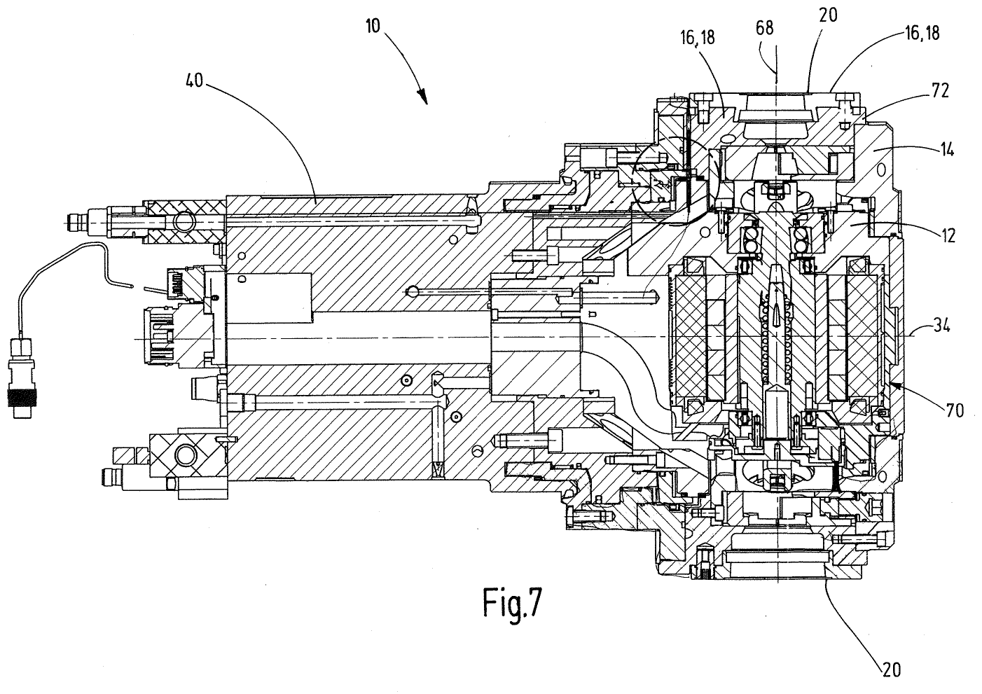

FIG. 7 shows a longitudinal section through a further embodiment of a tool turret, comparable to the solution according to FIG. 1 having an internal interface formation in the context of the implementation of the transmission link;

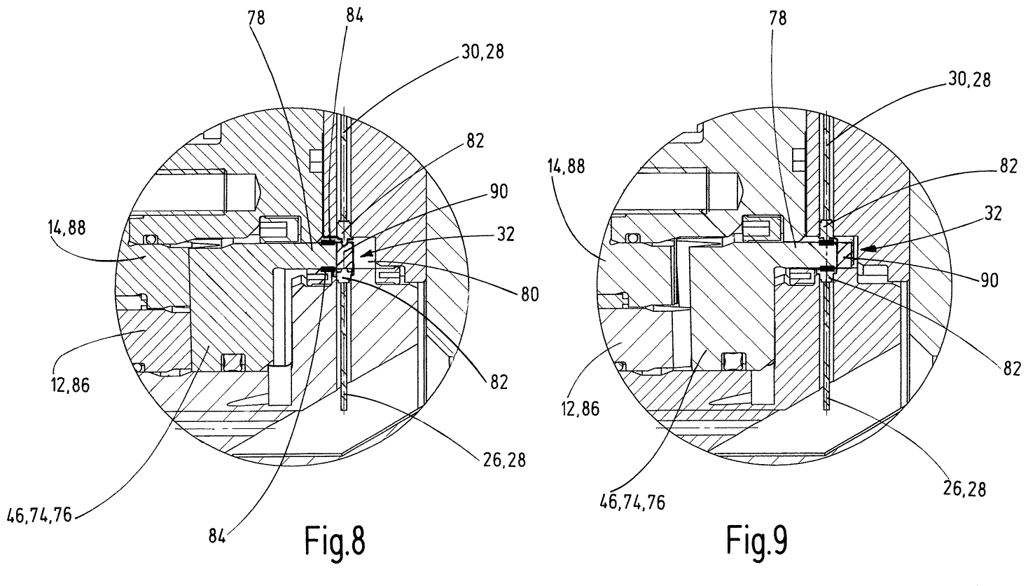

FIGS. 8 and 9 show the further contacting device according to FIG. 7, once in the contacting position and once the contactless position;

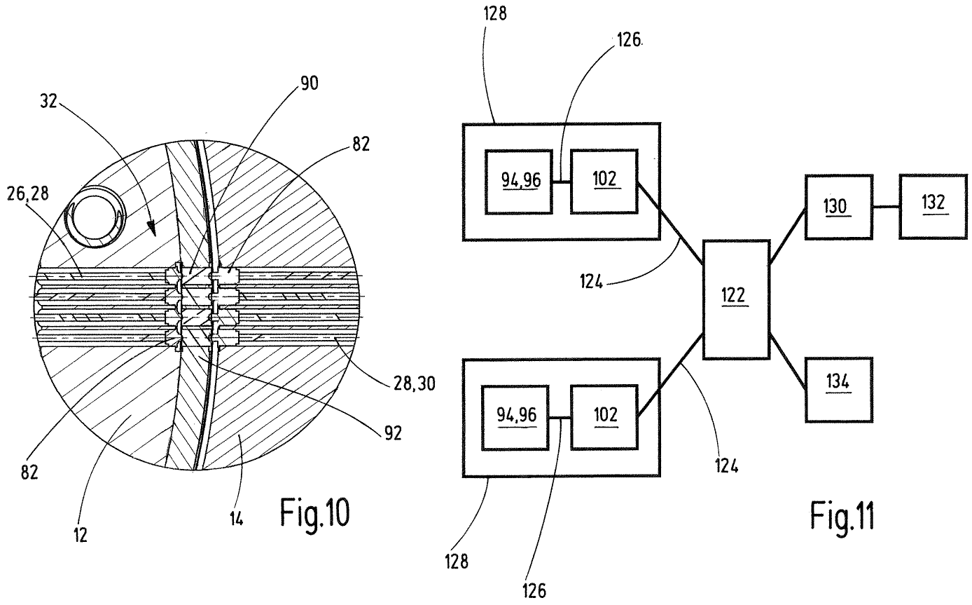

FIG. 10 shows a partial section concerning the contacting representation according to FIG. 8, viewed in a direction of view perpendicular to the drawing plane; and

FIG. 11 shows, in the manner of a block diagram, the essential components of the communication system, as it is preferably used for the machine devices according to the above figures.

FIGS. 1 and 2 show, as part of a communication system according to the invention, a machine device according to the invention, in the form of a tool turret 10, which corresponds to the tool turret disclosed in DE 10 2009 042 772 A1 or the tool turret disclosed in DE 10 2005 033 890 A1. The tool turret 10 has a stationary housing part 12 and a receiving part 14, rotatable relative to this stationary housing part 12, in the form of a tool disk 16, which can be fixed relative to the stationary housing part 12 in various fixing positions in predeterminable angular positions. The tool disk 16 has on its circumferential side 18 several individual receptacles 20, each for receiving a tool receptacle 22 for a tool holder 24, which corresponds to the tool receptacle disclosed in DE 198 24 692 A1 or in DE 10 2014 003 336 A1. The respective tool holder 24 is used for receiving a cutting working tool not shown in the figures.

Alternatively, the machine device may be formed as a turntable (not shown in the figures), which corresponds to the turntable disclosed in DE 198 53 590 C1. The turntable has a stationary housing part in the form of a stationary table part and a receiving part in the form of a rotatable table part encompassing the stationary table part.

The stationary housing part 12 has a first part 26 of a transmission link 28 and the receiving part 14 has several second parts 30 of the transmission link 28 (FIGS. 3, 4, 8, 9). The first part 26 and only one second part 30 of the transmission link 28 can be interconnected in an fixed position of the receiving part 14 by means of a contacting device 32 arranged between the stationary part 12 and the receiving part 14. When the receiving part 14 is released for rotation, the contacting device 32 separates the first part 26 and every second part 30 of the transmission link 28 from each other.

Several such transmission links 28 are provided, each of which is formed to convey information and/or energy and which, at least in the area of the contacting device 32, are arranged next to one another in such a way that, viewed in cross-section, their centers can be intersected by a joint plane, whose normal corresponds to the axis of rotation 34 of the receiving part 14.

A further contacting device 38 (FIGS. 3 to 5) is provided between the tool receptacle 22 and the receiving part 14 for connecting the second part 30 of the transmission link 28, extending through the receiving part 14, and a third part 36 of the transmission link 28, extending through the relevant tool receptacle 22.

Each of the transmission links 28 can be formed wireless, but in the figures is formed wired. If a wireless transmission link 28 is provided, the contact devices 32, 38 of this transmission link 28 can be at least partially omitted. If wired transmission links 28 are provided, every contacting device 32, 38 can be formed contactless, for instance, in particular resonant, inductive, capacitive or optical.

FIGS. 2 to 4 show a first embodiment of the contacting device 32 for connecting and disconnecting the first part 26 of the transmission link 28 to the relevant second part 30 of the transmission link 28.

In the first embodiment, the contacting device 32 has a further housing 42, which differs from the housing 40 of the tool turret 10 and is attached externally, i.e. from the outside, to the housing 40 of the stationary housing part 12 of the tool turret 10. A male connector part 44 is at least partially arranged in the further housing 42 of the contacting device 32, wherein said male connector part can be moved along the axis of rotation 34 of the receiving part 14 by means of an actuator 46, arranged in this housing 42, in the form of a linear drive. The linear drive is formed as an energizable actuating magnet 50, the actuating element 52 of which is connected to an end, facing away from the receiving part 14, of the male connector part 44. At least one transmission link part 54 of the first part 26 of the transmission link 28 extends through the connector part 44 and protrudes from the connector part 44 in the direction of the receiving part 14 in the form of a pin 56 for contacting purposes.

The actuating solenoid 50, which is formed to pull or push, is actuated in such a way that the male connector part 44, solely in the respective fixed position of the receiving part 14, starting from a position at least partially retracted into the further housing 42 of the contacting device 32, in which the male connector part 44 is arranged at a distance from a female connector part 58 of an external bridge part 60 (FIG. 3), is extended out of the further housing 42 of the contacting device 32 in the direction of the receiving part 14 until the end region, facing the receiving part 14, of the male connector part 44 engages with the female connector part 58 of the external bridge part 60, whereby the first part 26 and the respective second part 30 of the transmission link 28 are connected to one another (FIG. 4), wherein said second part 30 is assigned to the receiving part 14. Arranged in this way the male connector part 44 remains for at least almost the entire period of time, in which the receiving part 14 is arranged in its fixed position.

The bridge part 60 is formed with a right angle. The female connector part 58 for the male connector part 44 is provided at one leg 62 of the bridge part 60, wherein said one leg 62 extends perpendicular to the longitudinal axis of the linear drive 50 and is at least partially attached to the receiving part 14. A part of the further contacting device 38 for connecting the second part 30 of the transmission link 28 to the third part 36 of the transmission link 28, wherein said third part 36 extends through the tool receptacle 22, is provided at the other leg 64 of the bridge part 60, wherein said other leg 64 is arranged at a distance from the receiving part 14 and extends in parallel to the axis of rotation 34 of the receiving part 14. The part of the further contacting device 38, formed on the bridge part 60, is formed as a further female connector part 66.

The advantage of the contacting devices 32, 38 arranged outside the tool turret 10 is that a machine device that has already been delivered to a customer can be retrofitted afterwards with the communication system according to the invention.

FIGS. 7 to 10 show a second embodiment of the contacting device 32 for connecting and disconnecting the first part 26 of the transmission link 28 to the respective second part 30 of the transmission link 28.

In the second embodiment of the contacting device 32, the first part 26 of the transmission link 28 extends in parallel to the longitudinal axis 68 of the drive unit 70 of the tool turret 10 through the stationary housing part 12 and the second parts 30 of the transmission link 28 extend radially through the receiving part 14 perpendicular to the axis of rotation 34 of the receiving part 14, wherein all fictitious extensions of the second parts 30 of the transmission link 28 intersect at a point of the axis of rotation 34 of the receiving part 14. That second part 30 of the transmission link 28, which extends through the receptacle of the receiving part 14 currently coupled to the drive unit 70 of the tool turret 10, is arranged in parallel to the longitudinal axis 68 of the drive unit 70 of the tool turret 10.

A contacting device 32 as part of the transmission link 28 is formed between the stationary housing part 12 and the receiving part 14, wherein said contacting device 32 is conceived in the manner of an on/off switch. The contacting device 32 has an actuator device 46, which is formed by a serration unit 74. The serration unit 74 is formed as a ring, which bears an planar-sided serration 76 in the sense of a Hirth serration on its front facing the stationary housing part 12. On the side of the serration unit 74 opposite from the planar-sided serration 76, an annular and largely rectangular projection 78 is provided, which extends away from the serration unit 74 in the direction of the receptacles 20 into an annular recess 80 of the receiving part 14, into which the end of the first part 26 and of the second part 30 of the transmission link 28 projects, each end provided with a spring contacting element 82. The ring-shaped projection 78 has an insulating layer 84 on each of its ends facing and facing away from the nearest tool receptacle 22, wherein said insulating layers are provided opposite from the projection 78. Alternatively, only one of the two insulation layers 84 may be provided.

On the side of the planar-sided serration 76, a toothed disk 86 and a further toothed disk 88 are adjoining to the serration unit 74 in the direction of the axis of rotation 34 of the receiving part 14, wherein said toothed disks 86, 88 are arranged coaxially to the axis of rotation 34 of the receiving part 14 and coaxially to each other. On the side of the projection 78, a conductor 90 for conveying information and/or energy adjoins to the serration unit 74 in the direction of the axis of rotation 34 of the receiving part 14, wherein said conductor 90 is located at all times in the recess 80 of the receiving part 14. The conductor 90 can be an integral part of the projection 78 of the serration unit 74. The serration unit 74 and the toothed disk 86 are part of the stationary housing part 12, whereas the other toothed disk 88 is part of the receiving part 14.

The serration unit 74 can be moved by means of a fluid medium, preferably hydraulic medium, along the axis of rotation 34 of the receiving part 14 in such a way that in its one end position, the planar-sided ratchet teeth 76 engage with the stationary toothed disk 86 and with the further toothed disk 88 that can be rotated relative to the serration unit 74 and/or the stationary toothed disk 86. In this end position or fixed position, the other toothed disk 88 is rotationally fixed in a blocking position in relation to the toothed disk 86. Simultaneously, in this position the conductor 90 interconnects the first 26 and the second 30 part of the transmission link 28 with each other in that the respective spring contacting element 82 at the ends of the first part 26 and of the second 30 part of the transmission link 28 contacts the conductor 90 (FIG. 8).

When the serration unit 74 is moved, starting from the fixed position in the direction of the other end position, in which the serration unit 74, the toothed disk 86 and the further toothed disk 88 are disengaged in a releasing position, the front face of the serration unit 74 acts on the conductor 90 in the direction of the receptacles 20 in such a way, that the conductor 90 is brought out of contact with the respective spring contacting elements 82 of the first part 26 and of the second 30 part of the transmission link 28 and the respective spring contacting element 82 come into contact with the insulator 84 closest thereto. In this way, the transmission link 28 is interrupted (FIG. 9).

The end, facing the tool receptacle 22, of the second part 30 of the transmission link 28 is connected to another female connector part 66, which is located on the circumferential surface 18, facing the tool holder 24, of the tool turret 10.

FIG. 10 shows four transmission sections 28 arranged side by side in the area of the contacting device 32, the respective first 26 and second 30 part of the transmission section 28 of which are interconnected by means of a conductor 90. Every conductor 90 is arranged in a circumferential latching ring 92, wherein the conductors 90 are preferably cylindrical.

The advantage of the contacting devices 32, 38 arranged within the tool turret 10 is that the communication system according to the invention is protected against damage from outside, for instance against a collision during the operation of the machine device. In this way, relevant components, preferably all relevant components, of the communication system can be installed in the respective machine device, also protected from fluid, inside the machine device.

If provided, each information-conveying transmission link 28 is used to transmit sensor data of at least one data acquisition device 94 in the form of a sensor 96. A respective sensor 96 may be located on or in the machine device.

FIGS. 5 and 6 show spaces provided for a tool holder 24 in the tool receptacle 22, wherein in said spaces sensors 96 and the respective third part 36 of the transmission link 28 connected to this sensor 96 can be arranged. Ducts 100 of different lengths are inserted into the tool receptacle 22, starting from the side of the tool receptacle 22 facing away from the opening 98 for the tool holder 24 and extending in the direction of the side having the opening 98, wherein in each of said ducts 100 a sensor 96 having a transducer can be arranged (FIG. 6). In addition, a data collection device 102 for storing the sensor data is provided on the side of the tool receptacle 22 facing away from the opening 98 for a working tool (FIG. 5) and on this side a part of the further contacting device 38 in the form of a further male connector part 104 for connection to the further female connector part 66 is provided at the end of the tool receptacle 22 facing the receptacle 20. The corresponding components of the communication system arranged on this side are closed in a sealing manner by a cover part 106 as part of the housing 108 of the tool receptacle 22.

Each sensor 96 is connected to the further connector part 104 via the third part 36 of the transmission link 28 with the interposition of the data collection device 102 and can be formed as a temperature sensor, deformation sensor, pressure sensor, acceleration sensor, vibration sensor, humidity sensor, a sensor for structure-borne sound or as a microphone.

A sensor 96 in the form of a temperature sensor, for instance, can be inserted in every of the ducts 100 shown in FIG. 6, wherein the sensor 96 located furthest away from the receiving part 14 measures the temperature of a rear spindle bearing 112 of the tool receptacle 22 and the sensor 96 located nearest to the receiving part 14 measures the temperature of an input shaft 116 of the tool receptacle 22 and the sensor 96 located between these two sensors 96 measures the temperature of a front spindle bearing 120 of the tool receptacle 22.

If provided, the energy-conveying transmission link 28 is used to transmit a supply voltage for the respective sensors 96 or for an additional attachment device, not shown in the figures, such as a high-frequency spindle or a gripper.

FIG. 11 shows in the manner of a block diagram the communication system according to the invention having the machine device.

The communication system has a data evaluation device 122, which is referred to as a so called IQ box and which is connected to several, in FIG. 11 two, data collection devices 102 each via a bidirectional, wired transmission link 124 having the form of a bus system.

The respective data collection device 102 has a module for wireless data transmission, not shown in the figures, e.g. a Near Field Communication (NFC standard) module, which can be used to parametrize the working tool and/or the tool receptacle 22 of the tool turret 10 by means of an end device (not shown in the figures) in the form of a computer, whereas the reading of the parameters is performed by wire. In addition, this wireless interface can be used to update a software of the communication system.

Every data collection device 102 is connected in turn to at least the data acquisition device 94 in the form of the sensor 96 via a wired transmission link 126 each.

The respective data collection device 102 temporarily stores and digitizes the sensor data of the data acquisition devices 94 connected thereto. The data evaluation device 122 at least partially evaluates the collected, digitalized sensor data of the data collection devices 102 connected thereto.

Every data collection device 102 and the respective data acquisition devices 122 connected to this data collection device 102 are assigned to a component 128 of the machine device, of which these data acquisition devices 94 determine sensor values. The data evaluation device 122, on the other hand, is located at a distance from the machine device.

The data evaluation device 122 configures the bus participants, for instance the data acquisition devices 94 and/or the data collection devices 102, depending on these bus participants, thereby forming a self-configuring network. As a result, the components 128 of the machine device can be replaced easily and quickly because the configuration of the communication system automatically adapts to the new components 128 by means of the IQ box. This renders an active configuration of the communication system by a human unnecessary.

The data acquisition device 122 or the data collection device 102 acquires data regarding the current status of the machine device, such as the operating hours or the number of temperature excess. The data acquired by means of the data acquisition device 94 or by means of the data collection device 102 can be stored at least briefly in the data collection device 102. The status data can be read out either wire-bound or wirelessly via the wireless interface.

The data evaluation device 122 is connected to a data storage device 130, for instance a server of a cloud, on which the collected sensor data and/or status information of all components 128 of every machine device can be stored, evaluated further and from which the stored data can be retrieved. In this way, the processes of the communication system, in particular of the machine equipment, can be optimized and predictive service or predictive maintenance is enabled. The data storage device 130 is connected to end devices 132, such as computers in the form of PCs or mobile phones.

In addition or alternatively, the data evaluation device 122 is connected to a machine control 134 of the respective machine device, which permits a direct feedback of the status of the respective machine device. The communication system according to the invention can be used to process usage data of the machine devices, for instance a working histogram can be generated or the service life or the achievement of extreme sensor values can be monitored. Tool correction data can be read and written, for instance a exposed length or a correction value of a working tool. Based on the mass data in terms of Big Data, artificial intelligence can be trained and a digital model of the communication system having the machine devices already delivered can be created, and in this way service and sales concepts can be optimized.

1. A communication system consisting of at least one
data acquisition device (94) for acquiring sensor data of at least one machine device provided for cutting machining, preferably in real time,
data collection device (102) for digitizing the collected data, and
data evaluation device (122) for the collected digitized data.

2. A machine device, in particular as part of a communication system according to claim 1, in the form of a tool turret (10) or a rotary table, having a housing part (12) and a receiving part (14), which can be fixed relative thereto in predeterminable angular positions starting from a release position, characterized in that at least one part of at least one information- and/or energy-conveying transmission link (28) is formed between the parts (12, 14) in the fixed to each other state of the parts (12, 14) and is interrupted in the release position.

3. The machine device according to claim 1, characterized in that the respective transmission link (28) is established via a contacting device (32), which is conceived in a re-releasable form or contactless.

4. The machine device according to claim 1, characterized in that the information-conveying transmission link (28) is used to transmit sensor data and the power-conveying transmission link (28) is used to transmit a supply voltage for the respective sensor (96) or an additional attachment device.

5. The machine device according to claim 1, characterized in that at least one of the sensors (96) listed below is used as sensor data detecting means:
temperature sensor
deformation sensor
pressure sensor
acceleration sensor
vibration sensor,
humidity sensor,
structure-borne sound sensor including microphone.

6. The machine device according to claim 1, characterized in that the respective sensor (96) is installed in a tool receptacle (22) for a tool holder (24), which can be fixed in circumferentially arranged receptacles (20) on a tool disk (16) of a tool turret (10).

7. The machine device according to claim 1, characterized in that the respective sensors (96) on the tool receptacle (22) can be connected to parts of the respective transmission link (28) on the side of the pivotable receiving part (14) via a further contacting device (38).

8. The machine device according to claim 1, characterized in that the contacting device (32) at the stationary housing parts (12) has an actuator device (46), which actuates a male-female connector connection (44, 58) to the swivel receiving part (14) in one of its fixed machining positions.

9. The machine device according to claim 1, characterized in that the actuator device (46) comprises an energizable actuating magnet (50) or is formed from a re-releasable serration unit (74), in which under the influence of a medium a planar-sided ratchet teeth (76) engages with a stationary (86) and a toothed disk, which is rotatable (88) relative thereto, and in that in the locking position, in which all the serrations (76, 86, 88) are engaged with each other, the contacting device (32) is in its closed functional position establishing the transmission link (28) and is interrupted in the releasing position.

10. The machine device according to claim 1, characterized in that a part of the transmission link (28) is formed by a current-conveying part by components of the ratchet teeth (74).
